(19) United States
(12) Patent Application Publication
(10) Pub. No.: US 2004/0045319 A1
(43) Pub. Date: Mar. 11, 2004

(54) Method and device for sealing glass ampoules

(76) Inventors: Joachim Schussler, Birkenfeld (DE); Peter Fornsel, Spenge (DE); Christian Buske, Steinhagen (DE)

Correspondence Address: Richard M. Goldberg, Suite 419, 25 East Salem Street, Hackensack, NJ, 07601, US

(21) Appl. No.: 10/395,829

(22) Filed: Mar. 24, 2003

(30) Foreign Application Priority Data
Mar. 28, 2002 (EP) 02 007 113.0

(51) Int. Cl. C03B 23/18

(52) U.S. Cl. 65/34; 65/108; 65/113; 65/120; 65/270; 65/271; 65/276

(57) ABSTRACT

A method for opening or sealing glass ampoules (38) by melting the glass with the help of a jet (36) of a hot medium, characterized in that the medium is an atmospheric plasma, produced by an electric discharge.

The invention relates to a method for opening or sealing glass ampoules by melting the glass with the help of a jet of a hot medium, as well as to a device for carrying out the method.

Liquids, which must be protected reliably against contamination, especially serums for medical injections, frequently are filled into glass ampoules, which are then sealed airtight by a melting process. Previously, gas burners were used for this purpose and their flame was directed onto the part of the ampoule, which was to be melted.

When the ampoules are delivered in the sealed state, they must first be opened, by severing a cap of the ampoule, before they can be filled. A gas burner is preferably used also for this purpose, in order to ensure that the sterility of the ampoules is maintained.

However, gas burners can be operated only at a great expense and with high operating costs, since relatively expensive, combustible gases are required. A reliable supply of gases must be maintained and the gas-supplying systems must be protected carefully against leakages, so that there is no danger of explosion.

Frequently, the ampoules must be opened, filled and sealed in clean rooms, in order to avoid contamination of the liquids and the ampoules. The combustion process in the gas burner must therefore be controlled carefully, so that soot is not formed. The waste gases, formed during the combustion, may also prove to be harmful.

It is therefore an object of the invention to indicate a method and a device, with which glass ampoules can be opened and/or sealed easily, relatively inexpensively and without the danger of contamination.

Pursuant to the invention, this objective is accomplished for a method of the type named above, owing to the fact that the medium is an atmospheric plasma, which is produced by an electric discharge.

Since the plasma can be produced simply and energy efficiently by an electric discharge using air as working gas, the operating and equipment costs are reduced. In particular, there is no need to maintain a supply of gaseous fuels and an expensive and leak-proof gas-supplying system is not required. The high-energy efficiency is achieved mainly owing to the fact that the excited free radicals and ions in the plasma lead to a particularly effective transfer of heat from the plasma flame to the glass, which is to be melted. Moreover, the excited free radicals and ions have a sterilizing effect. A further significant advantage is to be seen therein that harmful combustion residues are not formed during the generation of the plasma. The method is therefore particularly suitable for applications, for which the purity and sterility requirements are high. It can, however, also be used advantageously in other applications, in which the glass is to be melted locally.

EP-B-0 761 415 and WO-A-01/43512 disclose plasma nozzles, for which a jet of atmospheric plasma is generated with the help of a high-frequency discharge. These plasma nozzles generate a plasma flame, which can also be expanded fan-shaped as required and which, with regard to its shape and flame temperature, is comparable with the flame of the previously used gas burner. These plasma nozzles are therefore particularly suitable for carrying out the inventive method. The flame configuration can be optimized, as required, by the appropriate choice of nozzle configuration, distance between electrodes, frequency, voltage and air throughput. Since the plasma nozzles also simulate the previously used gas burners in their external shape and their dimensions, already existing installations for opening and sealing glass ampoules can be converted without problems to the inventive method.

The device for carrying out the method is the object of claim 6.

Advantageous developments of the invention arise out of the dependent claims.

Examples of the invention are explained in greater detail in the following by means of the drawing, in which

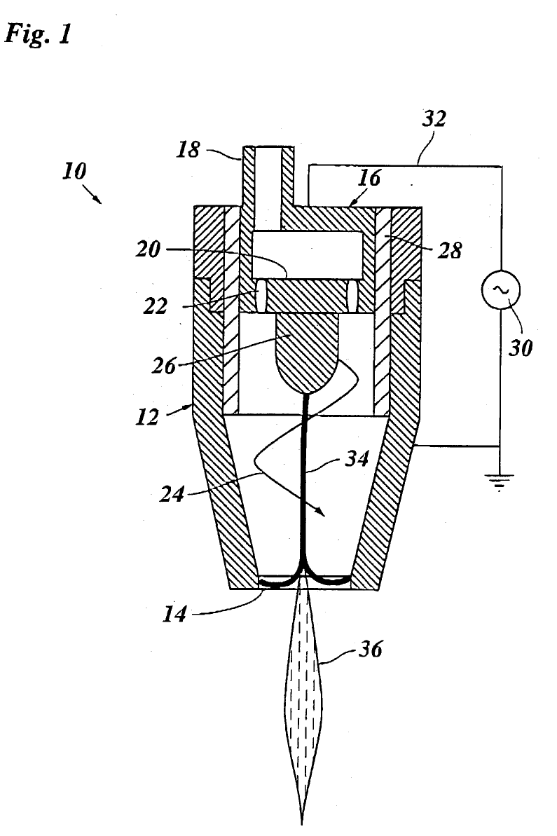

FIG. 1 shows a section through a plasma nozzle for carrying out the inventive method,

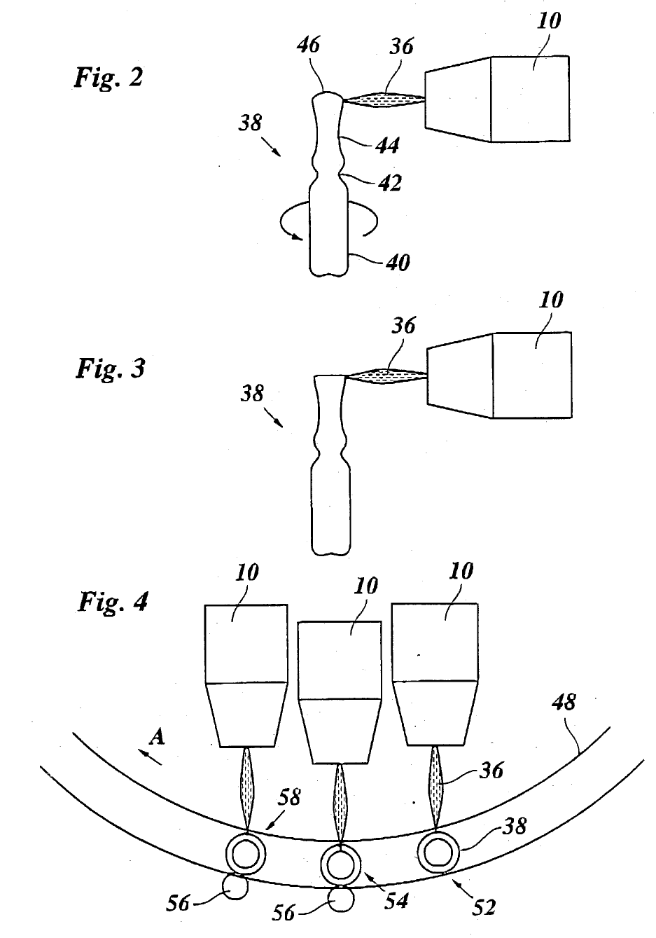

FIGS. 2 and 3 show diagrammatic representations for explaining a method for opening sealed glass ampoules,

FIG. 4 shows the essential parts of a device for opening and/or sealing glass ampoules in plan view and

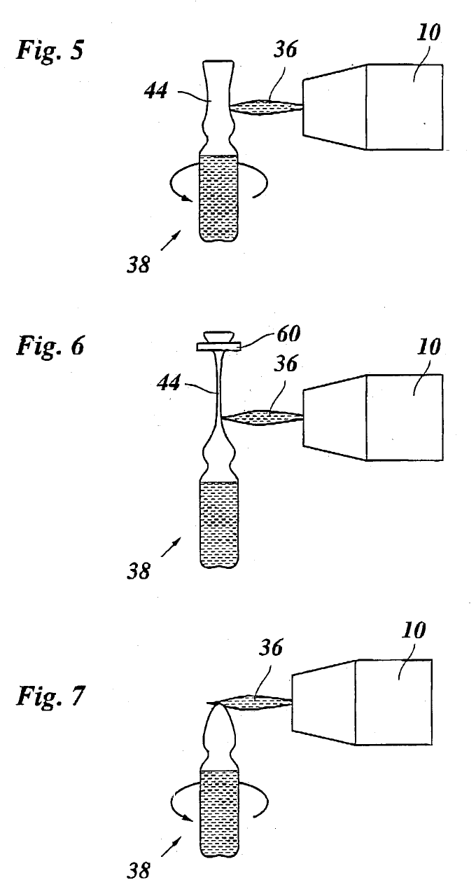

FIGS. 5 to 7 show different steps of a method for sealing glass ampoules.

A plasma nozzle 10, shown in FIG. 1, has a nozzle tube 12 of metal, which tapers conically toward an outlet opening 14. At the end, opposite to the outlet opening 14, the nozzle tube 12 has a twisting device 16 with an inlet 18 for a working gas, such as compressed air. A partition 20 of the twisting device 16 has a wreath of boreholes 22, which are at an angle to the circumferential direction and by means of which the working gas is twisted. The working gas therefore flows in the form of a vortex 24, the core of which extends along the longitudinal axis of the nozzle tube, through the downstream, conically tapering part of the nozzle tube.

At the center of the underside of the partition 20, an electrode 26 is disposed, which protrudes coaxially into the tapered section of the nozzle tube. The electrode 26 is connected electrically with the partition 20 and the remaining parts of the twisting device 16. The twisting device 16 is insulated electrically from the nozzle tube 12 by a ceramic tube 28. A high-frequency AC voltage, which is generated by a high-frequency transformer 30, is applied over the twisting device 16 to the electrode 26. The primary voltage can be controlled variably and is, for example, 300 to 500 V. the secondary voltage may amount to 1 to 5 kV or more. The frequency is, for example, of the order of the 1 to 50 kHz and can also be controlled. The twisting device 16 is connected with the high-frequency transformer 30 over a flexible high-frequency cable 32. The inlet 18 is connected over a tube, which is not shown, with a compressed air source with a variable throughput and the compressed air source preferably is combined with the high-frequency generator 30 into a supply unit. The nozzle tube 12 is grounded.

A high-frequency discharge is generated in the form of an electric arc 34 between the electrode 26 and the nozzle tube 12 by the voltage applied. Because of the twisting flow of the working gas, this electric arc is channelized in the vortex core on the axis of the nozzle tube 12, so that it branches only in the region of the outlet opening 14 to the wall of the nozzle tube12. The working gas, which rotates at a high flow velocity in the region of the vortex core and, with that, in the immediate vicinity of the electric arc 34, comes into intimate contact with the electric arc and, by these means, is converted partly into the plasma state, so that a jet 36 of an atmospheric plasma, approximately in the shape of a candle flame, emerges from the outlet opening 14 of the plasma nozzle 10. The temperature of the plasma jet 36 is, for example, of the order of 1,600° to 2,500° C. If the plasma jet 36 is directed onto the surface of a glass body, such as an ampoule, the glass, well dosed, can be softened and fused locally.

FIG. 2 shows a glass ampoule 38, which is to be filled under clean room conditions and then sealed tightly once again. The ampoule has a bulb 40, which is to be filled with a medicinal fluid and, at the upper end, a constricted neck 42, which is later on broken off or sawn off when the ampoule is opened. A so-called ampoule lance 44, which is sealed at the upper end by a cap 46, consisting of the glass of the ampoule, adjoins the neck 42 at the top. Accordingly the glass ampoule 38 is hermetically sealed in the state as delivered.

The cap 46 must be severed so that the ampoule can be filled. For this purpose, a hole is burned in the glass wall at one place in the periphery of the glass cap 46 with the help of the plasma jet 36 that is generated by the plasma nozzle 10. Subsequently the glass ampoule 38 is rotated and the cap 46 is cut off with the help of the plasma jet 36. The result is shown in FIG. 3. The glass ampoule 38, which is now open at the upper end, can then be transported to a filling station, which is not shown.

In a diagrammatic plan view, FIG. 4 shows a part of a device for opening glass ampoules 38 by the method described above. The glass ampoules 38 are transported in sequence onto a carousel 48, which is rotated stepwise in the direction indicated by an arrow A. In the example shown, several plasma nozzles 10 are disposed in a stationary manner at the inner periphery of the carousel 48. Only three plasma nozzles 10 are shown in the drawing. Alternatively, a larger number of plasma nozzles can be used.

The glass ampoules 38, supplied to the carousel 48, initially reach a station 52, in which the first plasma nozzle burns a hole in the glass wall, as shown in FIG. 2. During the next stop of the carousel 48, the glass ampoule is then rotated with the help, for example, of a friction roller 56 into the next station 54, so that, with the help of the plasma jet 36, a slot, extending in the peripheral direction, is produced in the glass wall. In the example shown, the slot produced in the station 54 extends over a peripheral angle of 180°. Subsequently the glass ampoule is transported to a station 58, in which the cap 46 is cut off completely by a further 180° cut, as shown in FIG. 3. The larger the number of plasma nozzles 10 used, the shorter is the working cycle in the individual stations 52 to 56, and therefore the higher is the productivity.

A method for sealing filled glass ampoules will now be described by means of FIGS. 5 to 7.

FIG. 5 shows a freshly filled glass ampoule 38. While the glass ampoule is being rotated about its central vertical axis, the plasma jet 36, generated by the plasma nozzle 10, is directed onto the ampoule lance 44, in order to soften the glass wall in the region of the ampoule lance.

Subsequently, the expanded part of the ampoule lance 44 is taken hold of by a holder 60 and pulled upward, so that the ampoule lance 44 is drawn down and constricted.

When the ampoule has been severed completely, the upper end of the glass ampoule is fused with the help of the plasma nozzle 36 while the rotation of the glass ampoule 36 is continued.

These processes can also be carried out in several steps and with several plasma nozzles 10 with a device, the construction of which is very similar to that of the device shown in FIG. 4.

For the method described here, the electric arc 34 for producing the plasma jet 36 remains largely within the plasma nozzle 10. However, when working with types of glass, which have a very high softening or melting temperature, such as when sealing quartz glass bulbs for halogen lamps, a higher plasma temperature can be attained owing to the fact that the electric arc 34 is drawn out of the plasma nozzle. This can be accomplished owing to the fact that a grounded counter electrode is disposed on the side of the glass bulb opposite to the plasma nozzle 10, so that the electric arc 34 does not jump over to the wall of the nozzle tube 12 and, instead, flows around the glass bulb and arcs over to the counter electrode.

1. A method for opening or sealing glass ampoules (38) by melting the glass with the help of a jet (36) of a hot medium, characterized in that the medium is an atmospheric plasma, produced by an electric discharge.

2. The method of claim 1, characterized in that the plasma is produced by a high-frequency discharge.

3. The method of claims 1 or 2, characterized in that air is used as working gas for producing the plasma.

4. The method of one of the preceding claims, characterized in that the working gas is twisted in a plasma nozzle (10).

5. The method of one of the preceding claims, characterized in that the plasma jet (36) is produced with the help of an electric arc (34), which, in a plasma nozzle (10), which has a grounded, electrically conducting nozzle tube (12), arcs over from an electrode (26) to the nozzle tube (12).

6. A device for opening or closing glass ampoules (38) with a transporting device (48) for the glass ampoules, characterized by at least one plasma nozzle (10), which is connected to a voltage source (30), produced by the electrical discharge of a jet (36) of an atmospheric plasma and disposed in such a manner at the transporting device (48), that the plasma jet (36) strikes the glass ampoules (38), which are supplied on the transporting device (48).

7. The device of claim 6, characterized in that the voltage source (30) is a high-frequency generator.

8. The device of claims 6 or 7, characterized in that the plasma nozzle (10) has a nozzle tube (12), through which a working gas is flowing, and an electrode (26), which is disposed coaxially in the nozzle tube.

9. The device of claim 8, characterized in that a twisting device (16) for twisting the working gas is disposed in the nozzle tube (12).
